(19) United States
(12) Patent Application Publication
(10) Pub. No.: US 2025/0141046 A1
(43) Pub. Date: May 1, 2025

(54) SECONDARY BATTERY, SEPARATOR FOR SECONDARY BATTERY AND METHOD FOR MANUFACTURING SAME

(71) Applicant: HONDA MOTOR CO., LTD., Tokyo (JP)

(72) Inventor: Toshiyuki ARIGA, Saitama (JP)

(21) Appl. No.: 18/900,922

(22) Filed: Sep. 30, 2024

(30) Foreign Application Priority Data
Oct. 27, 2023 (JP) 2023-184677

(51) Int. Cl. H01M 50/449; H01M 50/403

(52) U.S. Cl. CPC H01M 50/449; H01M 50/403

(57) ABSTRACT

A secondary battery according to one embodiment of the present invention includes a positive electrode layer, a negative electrode layer and a separator provided between the positive electrode layer and the negative electrode layer, in which the separator has a porous substrate, a conductive layer formed on one surface of the porous substrate, except for an edge region provided along at least one edge, and an insulation layer formed in the edge region; a difference in thickness between the conductive layer and the insulation layer is 1/10 or less of a total thickness of the porous substrate and the conductive layer and a thickness of the conductive layer is equal to or greater than a thickness of the insulation layer; and the separator is provided so that the conductive layer faces the negative electrode layer.

This application is based on and claims the benefit of priority from Japanese Patent Application No. 2023-184677, filed on 27 Oct. 2023, the content of which is incorporated herein by reference.

### BACKGROUND OF THE INVENTION

### Field of the Invention

The present invention relates to a secondary battery, a separator for a secondary battery and a method for manufacturing the same.

### Related Art

In order to allow more people to securely access affordable, reliable, sustainable and advanced energy, research and development on secondary batteries contributing to energy efficiency have been carried out. For example, in lithium ion secondary batteries, for the purpose of preventing metal deposition on negative electrode layers, it is known that a conductive porous body is placed between a positive electrode layer and a negative electrode layer and separators are placed respectively between the positive electrode layer and the conductive porous body, and the negative electrode layer and the conductive porous body (Patent Document 1).
Patent Document 1: Japanese Unexamined Patent Application, Publication No. 2015-141864

### SUMMARY OF THE INVENTION

Meanwhile, a challenge in the technology related to secondary batteries is to achieve high capacity. In order to achieve high capacity of secondary batteries, it is desired that a lithium metal secondary battery containing lithium as a negative electrode active material is put into practical use. However, in lithium metal secondary batteries, repetitive charge/discharge may cause accumulation of a SEI layer (solid electrolyte interphase) at the interface of a negative electrode current collector and lithium, resulting in generation of lithium dendrites at the time of charge. When lithium dendrites are generated, there is a risk that the generated lithium dendrites will penetrate a separator and cause a short circuit between a positive electrode layer and a negative electrode layer. Generation of lithium dendrites also may decrease the density of a metallic lithium layer deposited in the negative electrode layer to excessively expand the lithium secondary battery at the time of charge.

In view of the foregoing, it is an object of the present invention to provide a secondary battery that is less likely to short-circuit even after repetitive charge/discharge and is less likely to experience a reduction in the density of a metallic lithium layer of a negative electrode layer in the charged state, a separator useful for the secondary battery, and a method for manufacturing the same.

The present inventor found, in order to solve the problem, that providing a conductive layer on the surface of a separator facing a negative electrode active material layer is effective. However, according to the investigation by the present inventor, it was found that a separator provided with a conductive layer had an unevenness between the region of the conductive layer and the region without the conductive layer and the unevenness could cause wrinkles in the separator. If wrinkles form in the separator, there is a risk that a positive electrode layer and a negative electrode layer cannot be reliably insulated, and a short circuit may occur between the positive electrode layer and the negative electrode layer.

As a result of further investigation, the present inventor has found that it is effective to form an insulation layer in a region of the separator where a conductive layer is not provided, in which a difference in thickness between the insulation layer and the conductive layer is 1/10 or less of the total thickness of the conductive layer and a porous substrate, so that the thickness of the conductive layer is equal to or greater than the thickness of the insulation layer. The present invention therefore provides the following.

A first aspect of the present disclosure relates to a secondary battery including a positive electrode layer, a negative electrode layer, and a separator provided between the positive electrode layer and the negative electrode layer, in which the positive electrode layer has a positive electrode current collector and a positive electrode active material layer; the negative electrode layer has a negative electrode current collector; the separator has a porous substrate, a conductive layer formed on one surface of the porous substrate, except for an edge region provided along at least one edge, and an insulation layer formed in the edge region; a difference in thickness between the conductive layer and the insulation layer is 1/10 or less of a total thickness of the porous substrate and the conductive layer and a thickness of the conductive layer is equal to or greater than a thickness of the insulation layer; and the separator is provided so that the conductive layer faces the negative electrode layer.

According to the secondary battery of the first aspect, the conductive layer of the separator is provided to face the negative electrode layer, and thus lithium can deposit uniformly in the negative electrode layer at the time of charge. In addition, at the time of charge, due to electrons being supplied to the conductive layer, numerous lithium deposition sites are formed in the conductive layer, thereby decreasing the current density. A decreased current density at the time of charge can decrease overvoltage, thereby preventing decomposition of an electrolyte solution. In addition, because the separator has the edge region where the conductive layer is not formed and the insulation layer is formed in the edge region, the positive electrode layer and the negative electrode layer are less likely to short-circuit via the conductive layer. Further, because the difference in thickness between the conductive layer and the insulation layer is as small as 1/10 or less of the total thickness of the porous substrate and the conductive layer, wrinkles are less likely to occur and shape stability is high. In addition, because the thickness of the conductive layer facing the negative electrode layer is equal to or greater than the thickness of the insulation layer, gaps between the conductive layer and the negative electrode layer are less likely to occur. Consequently, the secondary battery of the first aspect is less likely to short-circuit even after repetitive charge/discharge, the density of the metallic lithium layer of the negative electrode layer in the charged state is less likely to decrease, resulting in high capacity.

A second aspect of the present disclosure relates to the secondary battery as described in the first aspect, in which the positive electrode current collector is connected to a positive electrode tab and the positive electrode tab extends towards the insulation layer of the separator.

According to the secondary battery of the second aspect, because the positive electrode tab is in contact with the insulation layer of the separator, the positive electrode tab is less likely to contact with the conductive layer. Thereby, the positive electrode layer and the negative electrode layer are less likely to short-circuit.

A third aspect of the present disclosure relates to the secondary battery described in the second aspect, in which the negative electrode layer has a negative electrode active material layer, and on a side connected to the positive electrode tab, an edge of the conductive layer is at a position outward of an edge of the positive electrode active material layer and an edge of the negative electrode active material layer is at the same position as the edge of the conductive layer or at a position outward of the edge of the conductive layer.

According to the secondary battery of the third aspect, because the negative electrode layer has the negative electrode active material layer and the distance between the edge of the positive electrode active material layer and the edge of the negative electrode active material layer is long, the positive electrode layer and the negative electrode layer are further less likely to short-circuit. Particularly, when the edge of the negative electrode active material layer is at a position outward of the edge of the conductive layer, edges of the positive electrode active material layer, the conductive layer, and the negative electrode active material layer are spread out in this order and the entire surface of the positive electrode active material layer faces the conductive layer via the porous substrate, and thus electrons can be efficiently given/received when lithium ions released from the positive electrode active material layer are deposited on the negative electrode active material layer. Thereby, performance of the secondary battery can be secured.

A fourth aspect of the present disclosure relates to the secondary battery described in the third aspect, in which the edge of the negative electrode active material layer is at a position outward of the edge of the conductive layer and the edge of the insulation layer on a side adjacent to the conductive layer is between the edge of the positive electrode active material layer and the edge of the negative electrode active material layer.

According to the secondary battery of the fourth aspect, because the conductive layer is less likely to contact the edge of the positive electrode active material layer, the positive electrode layer and the negative electrode layer are further less likely to short-circuit.

A fifth aspect of the present disclosure relates to a separator including a porous substrate, a conductive layer formed on one surface of the porous substrate, except for an edge region provided along at least one edge, and an insulation layer formed in the edge region, in which a difference in thickness between the conductive layer and the insulation layer is 1/10 or less of a total thickness of the porous substrate and the conductive layer and a thickness of the conductive layer is equal to or greater than a thickness of the insulation layer.

According to the separator of the fifth aspect, the conductive layer is provided to face the negative electrode active material layer, and thus in a secondary battery obtained, lithium can deposit uniformly in the negative electrode active material layer at the time of charge. This secondary battery has decreased overvoltage at the time of charge, thereby preventing decomposition of an electrolyte solution. In addition, because the separator has the edge region where the conductive layer is not formed and the insulation layer is formed in the edge region, the positive electrode layer and the negative electrode layer are less likely to short-circuit via the conductive layer. Further, because the difference in thickness between the conductive layer and the insulation layer is as small as 1/10 or less of the total thickness of the porous substrate and the conductive layer, wrinkles are less likely to occur and shape stability is high. In addition, because the thickness of the conductive layer facing the negative electrode layer is equal to or greater than the thickness of the insulation layer when being provided in a secondary battery, gaps between the conductive layer and the negative electrode layer are less likely to occur.

A sixth aspect of the present disclosure relates to a method for manufacturing a separator, including forming, while transporting an elongated porous substrate sheet in a longitudinal direction by roll-to-roll processing, a conductive layer in a form of a strip on one surface of the elongated porous substrate sheet, except for an edge region including at least one edge in a direction perpendicular to the longitudinal direction, and then forming, in the edge region, an insulation layer in a form of a strip so that a difference in thickness between the conductive layer and the insulation layer is 1/10 or less of a total thickness of the elongated porous substrate sheet and the conductive layer and a thickness of the conductive layer is equal to or greater than a thickness of the insulation layer.

In the elongated separator obtained by the method for manufacturing the separator according to the sixth aspect, the difference in thickness between the conductive layer and the insulation layer is as small as 1/10 or less of the total thickness of the elongated porous substrate sheet and the conductive layer and the unevenness between the conductive layer and the insulation layer can be absorbed when winding up into a roll, and thus wrinkles are less likely to occur and shape stability is high. In addition, in the resulting elongated separator, since the thickness of the conductive layer, which accounts for a large proportion of the separator, is equal to or greater than the thickness of the insulation layer formed in the edge region, localized bulging is less likely to occur when winding up into a roll and excessive stretch and occurrence of tensile break can be prevented. Thereby, according to the method for manufacturing the separator according to the sixth aspect, the separator having the conductive layer and the insulation layer can be efficiently manufactured by roll-to-roll processing.

A seventh aspect of the present disclosure relates to the method for manufacturing the separator described in the sixth aspect, in which the conductive layer is formed by any of a sputtering method, a die coating method and an inkjet method.

According to the method for manufacturing the separator of the seventh aspect, the conductive layer can be continuously and stably formed, resulting in high manufacturing efficiency of the separator.

An eighth aspect of the present disclosure relates to the method for manufacturing the separator described in the sixth or seventh aspect, in which the insulation layer is formed by an inkjet method.

According to the method for manufacturing the separator of the eighth aspect, the insulation layer can be continuously and stably formed, resulting in high manufacturing efficiency of the separator.

A ninth aspect of the present disclosure relates to the method for manufacturing the separator described in the sixth aspect, in which the conductive layer is formed by an inkjet method and the insulation layer is formed by an inkjet method.

According to the method for manufacturing the separator of the ninth aspect, the conductive layer and the insulation layer are formed by an inkjet method, and the conductive layer and the insulation layer can be easily formed at a similar rate. Thereby, processing can be simplified.

According to the present invention, it is possible to provide a secondary battery that is less likely to short-circuit even after repetitive charge/discharge and is less likely to experience a reduction in the density of a metallic lithium layer of a negative electrode layer in the charged state, a separator useful for the secondary battery, and a method for manufacturing the same.

### BRIEF DESCRIPTION OF THE DRAWINGS

FIG. 1 is a top view of a separator according to one embodiment of the present invention;

FIG. 2 is a sectional view taken along the II-II line of FIG. 1;

FIG. 3 is a sectional view of a secondary battery according to one embodiment of the present invention;

FIG. 4 is a sectional view of a secondary battery according to another embodiment of the present invention; and

FIG. 5 is a schematic view of a manufacturing device that can be used for a method for manufacturing a separator according to one embodiment of the present invention.

### DETAILED DESCRIPTION OF THE INVENTION

Embodiments of the present invention are hereinafter described by referring to the drawings. The embodiments indicated below, however, are only illustrative of the present invention and do not limit the present invention.

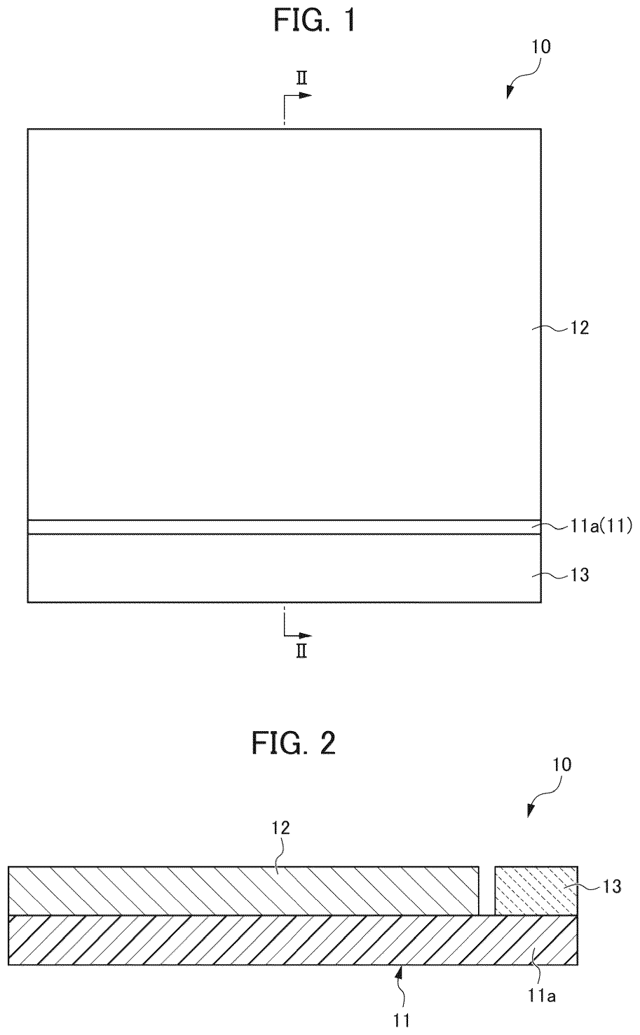

FIG. 1 is a top view of a separator according to one embodiment of the present invention. FIG. 2 is a sectional view taken along the II-II line of FIG. 1.

A separator according to the present embodiment includes a porous substrate 11, a conductive layer 12 formed on one surface of the porous substrate 11, except for an edge region 11a provided along at least one edge, and an insulation layer 13 formed in the edge region 11a. The difference in thickness between the conductive layer 12 and the insulation layer 13 is 1/10 or less of the total thickness of the porous substrate 11 and the conductive layer 12 and the thickness of the conductive layer 12 is equal to or greater than the thickness of the insulation layer 13. According to the present embodiment, the thickness of the conductive layer 12 is set to be the same as the thickness of the insulation layer 13.

Any porous substrate 11 may be used without limitation. The porous substrate 11 may be, for example, known porous substrates used for separators of lithium metal secondary batteries such as porous sheets and nonwoven fabric sheets. Examples of materials for the porous sheets include polyolefins such as polyethylene and polypropylene, aramid, polyimide and fluorine resins. Examples of materials for the nonwoven fabric sheets include glass fibers and cellulose fibers. The porous substrate 11 may have any thickness without limitation. The thickness is, however, preferably 10 μm or more in light of shielding lithium metal dendrites and preferably 15 μm or less in light of reducing resistance in batteries. More preferably, the porous substrate 11 has a thickness in the range of 10 to 12 μm. The porous substrate 11 may have any air permeability without limitation. The air permeability is, however, preferably 200 sec/100 mL or less, more preferably 150 sec/100 mL or less in light of reducing resistance in batteries. The porous substrate 11 may have any porosity without limitation. The porosity is, however, preferably in the range of 40% or more and 60% or less in light of uniform diffusion of lithium in the separator 10 and strength of the separator 10.

The conductive layer 12 may have any electrical conductivity without limitation. The electrical conductivity may be, however, in the range of 1.0×10¹ to 1.0×10⁵ S/cm. The surface resistivity may be, for example, 200 Ω/cm² or less. Materials for the conductive layer 12 used may be conductive materials such as metals and carbon nanotubes (CNTs). Examples of the metals may include Cu, Zn, Ti and Sn. The conductive materials may be used respectively alone or in combination of two or more. The conductive layer 12 may have a thickness in the range of, for example, 1 nm or more and 5000 nm (5 μm) or less.

The conductive layer 12 may be, for example, a layer of an aggregate of conductive material particles formed by a method for applying a coating solution of a conductive material, or a layer of a continuous film formed by sputtering or vapor deposition. When the conductive layer 12 is an aggregate of conductive material particles, the conductive material particles may have an average diameter in the range of 5 nm or more and 100 nm or less. The porous substrate 11 may have an average pore diameter that is, for example, one-fold or less relative to the average particle diameter of the conductive material particles.

The insulation layer 13 may have any insulation properties without limitation. For example, the withstand voltage together with the porous substrate 11 may be 500 V or more. The insulation layer 13 may be an organic material, an inorganic material or a composite of an organic material and an inorganic material. The insulation layer 13 may be, for example, a layer of an aggregate of inorganic particles formed by a method for applying a coating solution of inorganic particles, or a layer of a composite containing a resin filled with inorganic particles. The inorganic particles preferably have high heat resistance. The inorganic particles used may be, for example, alumina or boehmite.

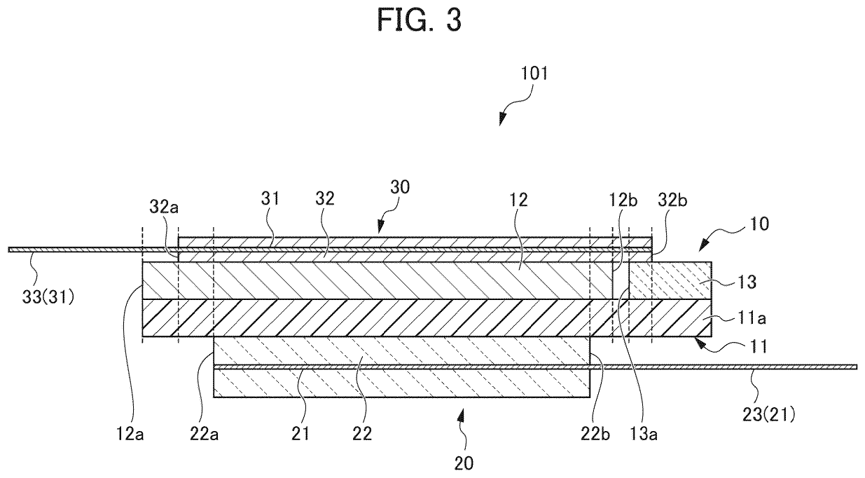

Next, a secondary battery containing the separator 10 according to the present embodiment is described. FIG. 3 is a sectional view of a secondary battery according to one embodiment of the present invention.

A secondary battery 101 according to the present embodiment includes a multilayer article having a positive electrode layer 20, a negative electrode layer 30 and a separator 10 provided between the positive electrode layer 20 and the negative electrode layer 30. The multilayer article is accommodated in an external packaging (not shown) together with an electrolyte solution (not shown). The external packaging includes a positive electrode terminal and a negative electrode terminal.

The positive electrode layer 20 has a positive electrode current collector 21 and positive electrode active material layers 22 stacked on both surfaces of the positive electrode current collector 21. The positive electrode current collector 21 is connected to a positive electrode tab 23 and the positive electrode tab 23 is connected to the positive electrode terminal. The negative electrode layer 30 has a negative electrode current collector 31 and negative electrode active material layers 32 stacked on both surfaces of the negative electrode current collector 31. The negative electrode current collector 31 is connected to a negative electrode tab 33 and the negative electrode tab 33 is connected to the negative electrode terminal. The secondary battery 101 is configured to be a lithium metal secondary battery. The lithium metal secondary battery is a secondary battery containing metallic lithium as the negative electrode active material layer 32, and lithium released from the positive electrode active material layer 22 at the time of charge is deposited on the surface of the negative electrode active material layer 32 to form a metallic lithium layer. Because of the above, the thickness of the negative electrode layer 30 increases at the time of charge. Meanwhile, at the time of discharge, lithium is released from the metallic lithium layer and absorbed to the positive electrode active material layer 22. Because of the above, the thickness of the negative electrode layer 30 decreases at the time of discharge. The negative electrode layer 30 therefore has a wide variation in thickness due to charge/discharge. The secondary battery 101 illustrated in FIG. 3 is in the discharged state.

The separator 10 is provided so that the conductive layer 12 faces the negative electrode active material layer 32. With regard to edges of the conductive layer 12, the positive electrode active material layer 22 and the negative electrode active material layer 32 of the separator 10 on the side connected to the positive electrode tab 23, the edge 12b of the conductive layer 12 is at a position outward of the edge 22b of the positive electrode active material layer 22 and the edge 32b of the negative electrode active material layer 32 is at a position outward of the edge of the conductive layer 12. The edge 13a of the insulation layer 13 on a side adjacent to the conductive layer 12 in the separator 12 is between the edge 22b of the positive electrode active material layer 22 and the edge 32b of the negative electrode active material layer 32. With regard to edges of the conductive layer 12, the positive electrode active material layer 22 and the negative electrode active material layer 32 of the separator 10 on the side connected to the negative electrode tab 33, the edge 12a of the conductive layer 12 is at a position outward of the edge 22a of the positive electrode active material layer 22 and the edge 32a of the negative electrode active material layer 32 is at a position inward of the edge 12a of the conductive layer 12. When edges of the positive electrode active material layer 22, the conductive layer 12 and the negative electrode active material layer 32 are spread out as described above, the entire surface of the positive electrode active material layer 22 faces the conductive layer 12 via the porous substrate 11, and thus electrons can be efficiently given/received when lithium ions released from the positive electrode active material layer are deposited on the negative electrode active material layer. The width of the edge region 11a (distance from the edge 12b of the conductive layer 12 to the edge of the porous substrate 11) may be, when for example, the negative electrode layer 30 protrudes relative to the positive electrode layer 20 by +2 mm and the separator 10 protrudes relative to the edge of the negative electrode layer 30 by +2 mm, more than 2 mm and less than 4 mm.

The conductive layer 12 is electrically connected to the negative electrode active material layer 32 in the discharged state and is electrically connected to metallic lithium deposited in the negative electrode active material layer 32 in the charged state. Accordingly, this makes the electrical potential of the conductive layer 12 and the negative electrode active material layer 32 the same, and thus lithium can be more uniformly deposited between the conductive layer 12 and the negative electrode active material layer 32. Because of the above, lithium dendrites are less likely to be generated, thus preventing a decrease in the density of the deposited lithium layer.

The electrical conductivity of the conductive layer 12 may be lower than the electrical conductivity of the negative electrode current collector 31. Accordingly, deposition of lithium on the side of the porous substrate 11 of the conductive layer 12 at the time of charge in a concentrated manner can be prevented, and damage due to shape changes of the conductive layer 12 resulting from the deposition of lithium in a concentrated manner can be prevented. The electrical conductivity of the conductive layer 12 may be, for example, in the range of 1/10- 1/100000 of the electrical conductivity of the negative electrode current collector 31.

Any material may be used for the positive electrode current collector 21 without limitation, and the material may be, for example, aluminum. The material of the positive electrode tab 23 may be the same as or different from the material of the positive electrode current collector 21. The positive electrode tab 23 may be integrally connected to the positive electrode current collector 21. In the present embodiment, the positive electrode tab 23 is formed by extending the positive electrode current collector 21 and is integrally connected to the positive electrode current collector 21. The material of the positive electrode terminal may be the same as or different from the material of the positive electrode tab 23. The positive electrode terminal may be integrally connected to the positive electrode tab 23.

The positive electrode active material layer 22 contains a positive electrode active material. Examples of the positive electrode active material include lithium cobalt oxide (LiCoO₂), lithium nickel oxide (LiNiO₂), LiNiₚMn_{q}CoᵣO₂ (p+q+r=1), LiNiₚAl_{q}CoᵣO₂ (p+q+r=1), lithium manganese oxide (LiMn₂O₄), heterologous element-substituted Li—Mn spinel represented by Li₁₊ₓMn_{2-x-y}M_{y}O₄ (x+y=2, M=at least one element selected from Al, Mg, Co, Fe, Ni or Zn), lithium titanium oxide (oxides containing Li and Ti) and lithium metal phosphate (LiMPO₄, M=at least one element selected from Fe, Mn, Co or Ni). The positive electrode active material layer 22 may contain various additives used as materials for positive electrode active material layers such as binders and conductivity aids.

Any material may be used for the negative electrode current collector 31 without limitation, and the material may be, for example, copper. The material of the negative electrode tab 33 may be the same as or different from the material of the negative electrode current collector 31. The negative electrode tab 33 may be integrally connected to the negative electrode current collector 31. In the present embodiment, the negative electrode tab 33 is formed by extending the negative electrode current collector 31 and is integrally connected to the negative electrode current collector 31. The material of the negative electrode terminal may be the same as or different from the material of the negative electrode tab 33. The negative electrode terminal may be integrally connected to the negative electrode tab 33.

The negative electrode active material layer 32 may contain lithium and a metal capable of forming an alloy with lithium. Examples of the metal capable of forming an alloy with lithium include Mg, Si, Au, Ag, In, Ge, Sn, Pb, Al and Zn. The negative electrode active material layer 32 may have a thickness of, for example, 50 μm or less.

The electrolyte solution contains an organic solvent and an electrolyte. Examples of the organic solvent that may be used include cyclic carbonates, linear carbonates, cyclic ethers, linear ethers, hydrofluoroethers, aromatic ethers, sulfones, cyclic esters, linear carboxylate esters and nitriles. Examples of the cyclic carbonate include ethylene carbonate, propylene carbonate, vinylene carbonate and fluoroethylene carbonate. Examples of the liner carbonate include dimethyl carbonate, diethyl carbonate and ethyl methyl carbonate. Examples of the cyclic ether include tetrahydrofuran, 2-methyltetrahydrofurane, tetrahydropyran, 1,3-dioxolane and 4-methyl-1,3-dioxolane. Examples of the linear ether include 1,2-dimethoxyethane, 1,2-diethoxyethane, ethoxymethoxyethane and diethyl ether. Examples of the hydrofluoroether include 1,1,2,2-tetrafluoroethyl-2,2,2-trifluoroethyl ether, 1,1,2,2-tetrafluoroethyl-2,2,3,3-tetrafluoropropyl ether, bis(2,2,2-trifluoroethyl)ether and 1,2-bis(1,1,2,2,-tetrafluoroethoxy)ethane. Examples of the aromatic ether include anisole. Examples of the sulfone include sulfolane and methylsulfolane. Examples of the cyclic ester include γ-butyrolactone. Examples of the linear carboxylate ester include acetate esters, butyrate esters and propionate esters. Examples of the nitrile include acetonitrile and propionitrile. The organic solvents may be used respectively alone or in combination of two or more.

The electrolyte is a source of lithium ions, which are a charge transfer medium, and contains a lithium salt. Examples of the lithium salt include LiPF₆, LiBF₄, LiClO₄, LiASF₆, LiCF₃SO₃, LiC(CF₃SO₂)₃, LiN(CF₃SO₂)₂ (LiTFSI), LiN(FSO₂)₂ (LiFSI) and LiBC₄O₈. The lithium salts may be used respectively alone or in combination of two or more. The concentration of the electrolyte is, for example, in the range of 1.5 to 4.0 mol/L.

The external packaging is configured to be stretchable according to the thickness change (particularly, thickness change of the negative electrode layer 30) of the secondary battery 10 due to charge/discharge. The material of the external packaging used may be a lamination film. The lamination film used may be a multilayer film having a three-layer structure including, from inside, an inner resin layer, a metal layer and an outer resin layer stacked in this order. The material of the inner resin layer and the outer resin layer used may be, for example, polyethylene terephthalate (PET), polyamide (nylon) or polypropylene (PP). The material of the metal layer may be, for example, aluminum.

In the secondary battery 101, the edge 32b of the negative electrode active material layer 32 on the side connected to the positive electrode tab 23 is at a position outward of the edge of the conductive layer 12. However, the positional relationship between the negative electrode active material layer 32 and the conductive layer 12 is not limited thereto.

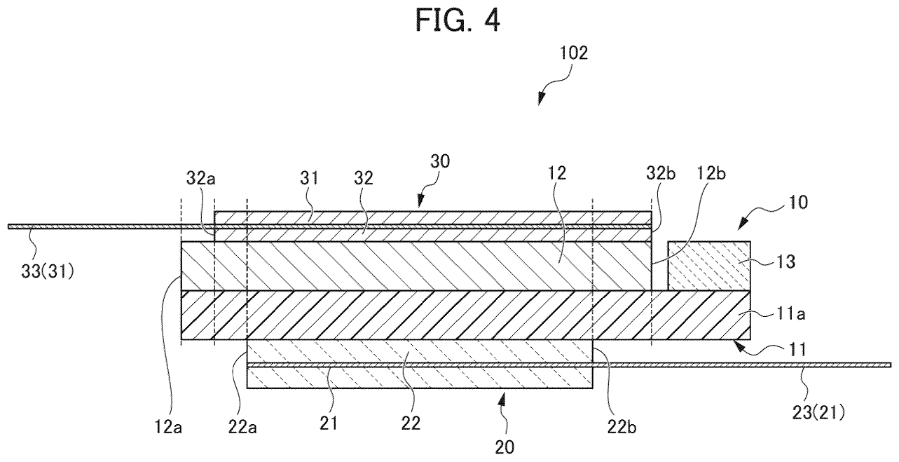

FIG. 4 is a sectional view of a secondary battery according to another embodiment of the present invention. The secondary battery 102 according to the present embodiment is identical to the secondary battery 101 described above except that, on the side connected to the positive electrode tab 23, the edge 12b of the conductive layer 12 is at a position outward of the edge 22b of the positive electrode active material layer 22 and the edge 32b of the negative electrode active material layer 32 is at the same position as the edge 12b of the conductive layer 12, and thus the same symbols are allocated and the explanations are omitted.

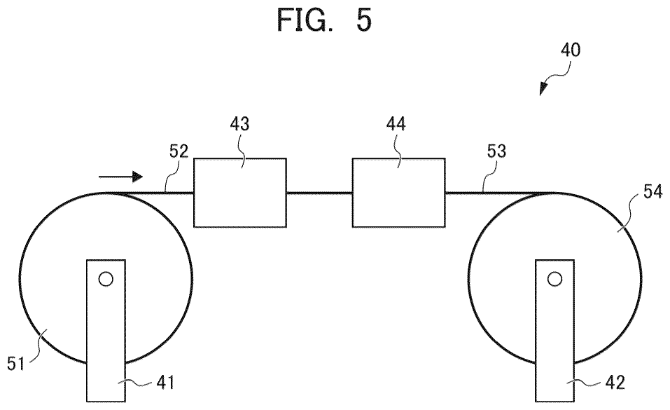

A method for manufacturing a separator 10 according to the present embodiment is now described. FIG. 5 is a schematic view of a manufacturing device that can be used for the method for manufacturing a separator according to one embodiment of the present invention.

A manufacturing device 40 includes a roll winding-off unit 41 and a roll winding-up unit 42. Between the roll winding-off unit 41 and the roll winding-up unit 42, a conductive layer forming unit 43 and an insulation layer forming unit 44 are provided.

The roll winding-off unit 41 is a unit that winds off an elongated porous substrate sheet 52 from a porous substrate sheet roll 51. The conductive layer forming unit 43 is a unit that forms a conductive layer on the surface of the elongated porous substrate sheet 52. The conductive layer may be formed by a sputtering method, a die coating method or an inkjet method. The insulation layer forming unit 44 is a unit that forms an insulation layer in the edge region on the surface of the elongated porous substrate sheet 52. The insulation layer may be formed by an inkjet method. The roll winding-up unit 42 is a unit that winds up the elongated porous substrate sheet (elongated separator sheet 53) including the conductive layer and the insulation layer formed therein to obtain a separator sheet roll 54.

The separator 10 is manufactured as follows. The elongated porous substrate sheet 52 wound off from the porous substrate sheet roll 51 by the roll winding-off unit 41 is transferred along the longitudinal direction (the direction of the arrow in FIG. 5). While transferring the elongated porous substrate sheet 52, the conductive layer forming unit 43 forms a conductive layer in the form of a strip on one surface of the elongated porous substrate sheet 52, except for an edge region including at least one edge in a direction perpendicular to the longitudinal direction. The insulation layer forming unit 44 then forms an insulation layer in the form of a strip in the edge region of the elongated porous substrate sheet 52. The thickness of the insulation layer is such that the difference in thickness between the conductive layer and the insulation layer is 1/10 or less of the total thickness of the elongated porous substrate sheet 52 and the conductive layer and the thickness of the conductive layer is equal to or greater than the thickness of the insulation layer. The elongated porous substrate sheet (elongated separator sheet 53) including the conductive layer and the insulation layer formed therein is then wound up to obtain the separator sheet roll 54. As described above, the separator sheet roll 54 can be manufactured by roll-to-roll processing. The elongated separator sheet 53 can be wound off from the obtained separator sheet roll 54 and cut to desired dimensions to obtain the separator 10.

According to the secondary batteries 101 and 102 according to the present embodiments having the above configurations, the conductive layer 12 of the separator 10 is provided to face the negative electrode active material layer 32, and thus lithium can deposit uniformly in the negative electrode active material layer 32 at the time of charge. In addition, at the time of charge, due to electrons being supplied to the conductive layer 12, numerous lithium deposition sites are formed in the conductive layer 12, thereby decreasing the current density. The decreased current density at the time of charge decreases overvoltage, thereby preventing decomposition of an electrolyte solution. In addition, because the separator 10 has the edge region 11a where the conductive layer 12 is not formed and the insulation layer 13 is formed in the edge region 11a, the positive electrode layer 20 and the negative electrode layer 30 are less likely to short-circuit via the conductive layer 12. Further, because the difference in thickness between the conductive layer 12 and the insulation layer 13 is as small as 1/10 or less of the total thickness of the porous substrate 11 and the conductive layer 12, wrinkles are less likely to occur and shape stability is high. In addition, because the thickness of the conductive layer 12 facing the negative electrode active material layer 32 is the same as the thickness of the insulation layer 13, gaps between the conductive layer 12 and the negative electrode active material layer 32 are less likely to occur. Consequently, the secondary batteries 101 and 102 according to the present embodiments are less likely to short-circuit even after repetitive charge/discharge, and are less likely to experience a reduction in the density of the metallic lithium layer of the negative electrode layer in the charged state, resulting in high capacity.

In the secondary batteries 101 and 102 according to the present embodiments, the positive electrode current collector 21 is connected to the positive electrode tab 23 and the positive electrode tab 23 extends towards the insulation layer 13 of the separator 10. As a result, the positive electrode tab 23 is in contact with the insulation layer 13 of the separator 10, and thus the positive electrode tab 23 is less likely to contact the conductive layer 12. Thereby, the positive electrode layer 20 and the negative electrode layer 30 are less likely to short-circuit.

In the secondary batteries 101 and 102 according to the present embodiments, the edge of the conductive layer 12 on the side connected to the positive electrode tab 23 is at a position outward of the edge 22b of the positive electrode active material layer 22 and the edge 32b of the negative electrode active material layer 32 is at the same position as the edge 12b of the conductive layer 12 or at a position outward of the edge 12b of the conductive layer 12. As a result, the distance between the edge 22b of the positive electrode active material layer 22 and the edge of the negative electrode active material layer 32 is long, and thereby, the positive electrode layer 20 and the negative electrode layer 30 are further less likely to short-circuit. In the secondary battery 101, the edge 32b of the negative electrode active material layer 32 is at a position outward of the edge 12b of the conductive layer 12 and the edges of the positive electrode active material layer 22, the conductive layer 12 and the negative electrode active material layer 32 spread out in this order, thereby securing performances of the secondary battery 101. Further, in the secondary battery 101, the edge 13a of the insulation layer 13 on a side adjacent to the conductive layer 12 is between the edge 22b of the positive electrode active material layer 22 and the edge 32b of the negative electrode active material layer 32 and the conductive layer 12 is less likely to contact the edge 22b of the positive electrode active material layer 22, and thereby the positive electrode layer 20 and the negative electrode layer 30 are further less likely to short-circuit.

According to the separator 10 of the present embodiment, the conductive layer 12 is provided to face the negative electrode active material layer 32, and thus in a secondary battery obtained, lithium can deposit uniformly in the negative electrode active material layer 32 at the time of charge. This secondary battery has decreased overvoltage at the time of charge, thereby preventing decomposition of an electrolyte solution. In addition, because the separator 10 according to the present embodiment has the edge region 11a where the conductive layer 12 is not formed and the insulation layer 13 is formed in the edge region 11a, the positive electrode layer 20 and the negative electrode layer 30 are less likely to short-circuit via the conductive layer 12. Further, because the difference in thickness between the conductive layer 12 and the insulation layer 13 is as small as 1/10 or less of the total thickness of the porous substrate and the conductive layer, wrinkles are less likely to occur and shape stability is high. In addition, when being arranged in a secondary battery, because the thickness of the conductive layer 12 facing the negative electrode active material layer 32 is the same as the thickness of the insulation layer 13, gaps between the conductive layer 12 and the negative electrode active material layer 32 are less likely to occur.

In the elongated separator sheet 53 obtained by the method for manufacturing the separator 10 according to the present embodiment, the difference in thickness between the conductive layer and the insulation layer is as small as 1/10 or less of the total thickness of the porous substrate and the conductive layer and the unevenness between the conductive layer and the insulation layer can be absorbed when winding up into a roll, and thus wrinkles are less likely to occur and shape stability is high. In addition, in the resulting elongated separator sheet 53, since the thickness of the conductive layer, which accounts for a large proportion of the separator, is equal to or greater than the thickness of the insulation layer formed in the edge region, localized bulging is less likely to occur when winding up into a roll and excessive stretch and occurrence of tensile break can be prevented. Thereby, according to the method for manufacturing the separator 10 according to the present embodiment, the separator 10 having the conductive layer 12 and the insulation layer 13 can be efficiently manufactured by roll-to-roll processing.

In the method for manufacturing the separator 10 according to the present embodiment, the conductive layer can be continuously and stably formed by any of a sputtering method, a die coating method and an inkjet method, resulting in high manufacturing efficiency of the separator. By forming the insulation layer by an inkjet method, the insulation layer can be continuously and stably formed, resulting in high manufacturing efficiency of the separator. When the conductive layer is formed by an inkjet method and the insulation layer is formed by an inkjet method, the conductive layer and the insulation layer can be easily formed at a similar speed. Thereby, processing can be simplified.

Embodiments of the present invention have been described hereinabove. The present invention is not limited to the above embodiments and may be variously modified. For example, according to the present embodiment, the conductive layer 12 and the insulation layer 13 of the separator 10 have the same thickness. However, as long as the difference in thickness between the conductive layer 12 and the insulation layer 13 is 1/10 or less of the total thickness of the porous substrate 11 and the conductive layer 11, the thickness of the conductive layer 12 may be greater than the thickness of the insulation layer 13. In this case, the difference in thickness between the conductive layer 12 and the insulation layer 13 may be in the range of, for example, 0.01 μm or more and 2 μm or less. According to the present embodiment, the negative electrode layer 30 has a negative electrode current collector 31 and negative electrode active material layers 32 stacked on both surfaces of the negative electrode current collector 31. However, the structure of the negative electrode layer 30 is not limited thereto. For example, the negative electrode active material layer 32 may be omitted. In this case, lithium is deposited on the surface of the negative electrode current collector 31 at the time of charge to form a lithium layer.

### EXPERIMENTAL EXAMPLES

Effects of providing the conductive layer 12 on the side of the negative electrode layer 30 of the separator 10 are explained by way of experimental examples.

### Experimental Example 1

### (Preparation of Separator)

An insulating porous film (thickness: 20 μm, porosity: 58%, air permeability: 92 sec/100 mL) was prepared. On one surface of the insulating porous film, a copper conductive layer having a thickness of 0.08 μm was formed by RF sputtering. The insulating porous film having the copper conductive layer formed thereon was punched to the size of 40 mm×50 mm to obtain a separator.

### (Preparation of Positive Electrode Layer)

Acetylene black (AB) as an electron conductive material, polyvinylidene fluoride (PVDF) as a binder and polyvinylpyrrolidone (PVP) as a dispersant were preliminarily mixed with N-methyl-2-pyrrolidone (NMP) as a dispersion medium and subjected to wet mixing on a planetary centrifugal mixer to obtain a pre-mixed slurry. The obtained pre-mixed slurry was then mixed with Li₁Ni_{0.8}Co_{0.1}Mn_{0.1}O₂ (NCM811) as a positive electrode active material and a pre-doping material and subjected to dispersion on a planetary mixer to obtain a positive electrode active material paste. NCM811 has a median diameter of 12 μm. The obtained positive electrode active material paste was then applied on an aluminum positive electrode current collector without a primer layer, dried and pressed with a rolling press and then dried in vacuum at 120° C. to form a positive electrode plate having a positive electrode active material layer. The obtained positive electrode plate was punched to the size of 30 mm×40 mm to obtain a positive electrode layer.

### (Preparation of Negative Electrode Layer)

A clad material containing a copper foil (negative electrode current collector, electrical conductivity: 6.5×10⁶ S/cm) having a thickness of 10 μm joined with a lithium foil (negative electrode active material layer) having a thickness of 20 μm was prepared. The clad material was punched to the size of 34 mm×44 mm to obtain a negative electrode layer.

### (Electrolyte Solution)

An electrolyte solution prepared contained LiFSI dissolved at a concentration of 4 mol/L in 1,2-dimethoxyethane (DME).

### (Preparation of Lithium Metal Secondary Battery)

On the surface of the negative electrode current collector on the side of the lithium foil, the copper conductive layer of the separator was stacked, and on the surface of the separator opposite to the side of the copper conductive layer, the positive electrode active material layer of the positive electrode layer was stacked, thereby preparing an electrode multilayer article containing the negative electrode layer, the separator and the positive electrode layer stacked in this order. Next, a positive electrode terminal was attached to the positive electrode current collector of the obtained electrode multilayer article via a positive electrode tab and a negative electrode terminal was attached to the copper foil of the negative electrode current collector via a negative electrode tab. The multilayer article having the positive electrode terminal and the negative electrode terminal attached thereto was placed in a bag made of a lamination film, the electrolyte solution was then placed in the bag and the bag made of a lamination film was sealed, thereby preparing a lithium metal secondary battery.

### Experimental Example 2

A lithium metal secondary battery was prepared in the same manner as in Experimental Example 1 except that in preparation of the separator, a conductive layer made of zinc having a thickness of 0.06 μm was formed by RF sputtering instead of the copper conductive layer.

### Experimental Example 3

A lithium metal secondary battery was prepared in the same manner as in Experimental Example 1 except that in preparation of the separator, a conductive layer made of carbon nanotubes (CNTs) having a thickness of 2.1 μm was formed by application instead of the copper conductive layer. The carbon nanotube conductive layer was formed as follows. To a solvent of N-methyl-N-pyrrolidinone (NMP), carbon nanotubes were placed in an amount resulting in a solid concentration of 4% by mass, and PVDF (#9300, manufactured by Kureha Corporation) as a binder was placed in an amount of 5 parts by mass relative to 95 parts by mass of the carbon nanotubes. A planetary centrifugal mixer was then used for dispersion treatment under conditions of 1000 rpm for 10 minutes to prepare a coating solution. The obtained coating solution was applied to the surface of the insulating porous film using a doctor blade before drying.

### Experimental Example 4

A lithium metal secondary battery was prepared in the same manner as in Experimental Example 1 except that in preparation of the separator, a conductive layer made of tin having a thickness of 0.06 μm was formed by RF sputtering instead of the copper conductive layer.

### Comparative Experimental Example 1

A lithium metal secondary battery was prepared in the same manner as in Experimental Example 1 except that in preparation of the separator, the copper conductive layer was not formed.

### [Evaluation]

The separators prepared in the experimental examples were measured for electrical conductivity, surface resistivity and peeling strength of conductive layers according to the methods indicated below. Table 1 indicates the results thereof together with materials, coating methods and thickness of the conductive layers of the separators. The occurrence of short-circuit and the rate of increase of lithium thickness for the lithium metal secondary batteries prepared in the experimental examples and comparative experimental example were measured according to the methods indicated below. Table 1 indicates the results thereof.

### (Electrical Conductivity and Surface Resistivity of Conductive Layer)

Electrical conductivity and surface resistivity were measured using a high precision high functional resistivity meter (manufactured by Nittoseiko Analytech Co., Ltd., Loresta GP TCP-600).

### (Peeling Strength)

To an adhesive tape having a width of 2.5 cm pressed to a fixed plate, the conductive layer having a length of 5.0 cm and a width of 2.5 cm was pressed. One edge of the conductive layer was then folded back 180 degrees and pulled up using a motorized test stand (manufactured by Imada Co., Ltd.) at a rate of 300 mm/min to peel the conductive layer from an insulating porous film. The load required from the start of peeling of the conductive layer till the end of peeling was measured with a digital force gauge (manufactured by Imada Co., Ltd.). The peeling strength was obtained as a value dividing the average of the resulting loads by the width of the adhesive tape.

### (Occurrence of Short-Circuit in Lithium Metal Secondary Battery)

A lithium metal secondary battery immediately after preparation was left to stand at a measurement temperature of 25° C. for 24 hours. The lithium metal secondary battery after standing still was subjected to three cycles of first charge/discharge cycle indicated below and then 50 cycles of second charge/discharge cycle indicated below, and the occurrence of short-circuit in the lithium metal secondary battery was observed. When the charging capacity of a lithium metal secondary battery was 105% or more relative to the discharging capacity before charge, it was determined that short-circuit occurred.

### (First Charge/Discharge Cycle)

Charge was carried out under conditions in which constant current charge was carried out at a current of 2.2 mA until 4.300 V and then constant voltage charge was carried out at a voltage of 4.300 V for 60 minutes. Discharge was carried out under conditions in which constant current discharge was carried out at a current of 4 mA until 2.65 V. Between the discharge and the charge, the batteries were left to stand for 30 minutes.

### (Second Charge/Discharge Cycle)

Charge was carried out under conditions in which constant current charge was carried out at a current of 74 mA until 3.823 V, at a current of 52 mA until 4.051 V, at a current of 46 mA until 4.173 V and at a current of 22 mA until 4.300 V and then constant voltage charge was carried out at a voltage of 4.300 V for 90 minutes. Discharge was carried out under conditions in which constant current discharge was carried out at a current of 18 mA until 2.65 V. Between the discharge and the charge, the batteries were left to stand for 30 minutes.

### (Rate of Increase of Lithium Thickness in Lithium Metal Secondary Battery)

The thickness T1 (μm) of a negative electrode layer at the time of the initial charge and the thickness (total thickness of a negative electrode current collector and a metallic lithium layer) T2 (μm) of the negative electrode layer after 50 cycles of charge were measured and the rate T (μm/cycle) of increase of lithium thickness was calculated from the formula indicated below:

$$T ( μm / cycle ) = ( T 2 - T 1 ) / 50$$

The thickness T1 (μm) of the negative electrode layer at the time of the initial charge was measured as follows. A lithium metal secondary battery immediately after preparation was left to stand at a measurement temperature of 25° C. for 24 hours. The lithium metal secondary battery after standing still was subjected to three cycles of the first charge/discharge cycle indicated above. Constant current charge was then carried out at a current of 14.7 mA until 4.300 V and then constant voltage charge was carried out at a voltage of 4.300 V for 60 minutes, thereby charging the lithium metal secondary battery. The charged lithium metal secondary battery was left to stand for 30 minutes and then dismantled, the negative electrode layer was removed and the thickness thereof was measured as the thickness T1 of the negative electrode layer.

The thickness T2 of the negative electrode layer after 50 cycles of charge was measured as follows. A lithium metal secondary battery immediately after preparation was left to stand at a measurement temperature of 25° C. for 24 hours. The lithium metal secondary battery after standing still was subjected to three cycles of the first charge/discharge cycle indicated above and then 50 cycles of the second charge/discharge cycle indicated above. Constant current charge was then carried out at a current of 14.7 mA until 4.300 V and then constant voltage charge was carried out at a voltage of 4.300 V for 60 minutes, thereby charging the lithium metal secondary battery. The charged lithium metal secondary battery was left to stand for 30 minutes and then dismantled, the negative electrode layer was removed and the thickness thereof was measured as the thickness T2 of the negative electrode layer.

TABLE 1

| | | | | | | | Evaluation results of | |
|---|---|---|---|---|---|---|---|---|
| | Conductive layer | | | | | | secondary battery | |
| | | | | Electrical | Surface | Peeling | Occurrence | Rate of increase of |
| | | Coating | Thickness | conductivity | resistivity | strength | of short- | lithium thickness |
| | Material | method | (μm) | (S/cm) | (Ω/cm²) | (N/m) | circuit | (μm/cycle) |
| Experimental | Cu | RF | 0.08 | 3.8 × 10⁴ | 3.5 | 260 | No | 0.42 |
| Example 1 | | sputtering | | | | | | |
| Experimental | Zn | RF | 0.06 | 3.6 × 10³ | 200 | 270 | No | 0.50 |
| Example 2 | | sputtering | | | | | | |
| Experimental | CNT | Application | 2.10 | 1.0 × 10¹ | 83 | 0.5 | No | 0.56 |
| Example 3 | | | | | | | | |
| Experimental | Sn | RF | 0.10 | 6.3 × 10² | 190 | 270 | No | 0.52 |
| Example 4 | | sputtering | | | | | | |

| | | | |
|---|---|---|---|
| Comparative | — | Yes | 1.00 |
| Experimental | | | |
| Example 1 | | | |

As indicated in Table 1, it was found that the lithium metal secondary batteries of Experimental Examples 1 to 4 including separators having conductive layers are less likely to short-circuit even after repetitive charge/discharge, respectively have a low rate of increase of lithium thickness and respectively have metallic lithium layers formed by charge that are dense and have high density. On the other hand, it was found that the lithium metal secondary battery of Comparative Experimental Example 1 including a separator without a conductive layer tends to suffer from a short-circuit after repetitive charge/discharge and has a high rate of increase of lithium thickness, and thus has a metallic lithium layer formed by charge that is loose and has low density.

### EXPLANATION OF REFERENCE NUMERALS

10 Separator
11 Porous substrate
11a Edge region
12 Conductive layer
13 Insulation layer
20 Positive electrode layer
21 Positive electrode current collector
22 Positive electrode active material layer
23 Positive electrode tab
30 Negative electrode layer
31 Negative electrode current collector
32 Negative electrode active material layer
33 Negative electrode tab
40 Manufacturing device
41 Roll winding-off unit
42 Roll winding-up unit
43 Conductive layer forming unit
44 Insulation layer forming unit
51 Porous substrate sheet roll
52 Elongated porous substrate sheet
53 Elongated separator sheet
54 Separator sheet roll
101, 102 Secondary battery

What is claimed is:

1. A secondary battery comprising a positive electrode layer, a negative electrode layer, and a separator provided between the positive electrode layer and the negative electrode layer, wherein
the positive electrode layer has a positive electrode current collector and a positive electrode active material layer,
the negative electrode layer has a negative electrode current collector,
the separator has a porous substrate, a conductive layer formed on one surface of the porous substrate, except for an edge region provided along at least one edge, and an insulation layer formed in the edge region, a difference in thickness between the conductive layer and the insulation layer is 1/10 or less of a total thickness of the porous substrate and the conductive layer and a thickness of the conductive layer is equal to or greater than a thickness of the insulation layer, and
the separator is provided so that the conductive layer faces the negative electrode layer.

2. The secondary battery according to claim 1, wherein the positive electrode current collector is connected to a positive electrode tab, and
the positive electrode tab extends towards the insulation layer of the separator.

3. The secondary battery according to claim 2, wherein the negative electrode layer has a negative electrode active material layer, and on a side where the positive electrode tab is provided, an edge of the conductive layer is at a position outward of an edge of the positive electrode active material layer and an edge of the negative electrode active material layer is at the same position as the edge of the conductive layer or at a position outward of the edge of the conductive layer.

4. The secondary battery according to claim 3, wherein the edge of the negative electrode active material layer is at a position outward of the edge of the conductive layer and the edge of the insulation layer on a side adjacent to the conductive layer is between the edge of the positive electrode active material layer and the edge of the negative electrode active material layer.

5. A separator comprising a porous substrate, a conductive layer formed on one surface of the porous substrate, except for an edge region provided along at least one edge, and an insulation layer formed in the edge region, wherein
a difference in thickness between the conductive layer and the insulation layer is 1/10 or less of a total thickness of the porous substrate and the conductive layer and a thickness of the conductive layer is equal to or greater than a thickness of the insulation layer.

6. A method for manufacturing a separator, comprising forming, while transporting an elongated porous substrate sheet in a longitudinal direction by roll-to-roll processing, a conductive layer in a form of a strip on one surface of the elongated porous substrate sheet, except for an edge region including at least one edge in a direction perpendicular to the longitudinal direction, and then forming, in the edge region, an insulation layer in a form of a strip so that a difference in thickness between the conductive layer and the insulation layer is 1/10 or less of a total thickness of the elongated porous substrate sheet and the conductive layer and thick a thickness of the conductive layer is equal to or greater than a thickness of the insulation layer.

7. The method for manufacturing the separator according to claim 6, wherein the conductive layer is formed by any of a sputtering method, a die coating method and an inkjet method.

8. The method for manufacturing the separator according to claim 6, wherein the insulation layer is formed by an inkjet method.

9. The method for manufacturing the separator according to claim 6, wherein the conductive layer is formed by an inkjet method and the insulation layer is formed by an inkjet method.
